(19) United States
(12) Patent Application Publication
(10) Pub. No.: US 2012/0210755 A1
(43) Pub. Date: Aug. 23, 2012

(54) YOKE DEVICE FOR USE IN COMBINATION WITH A SECURITY DEVICE

(75) Inventor: Gary Mark Shafer, Charlotte, NC (US)

(73) Assignee: CHECKPOINT SYSTEMS, INC., Philadelphia, PA (US)

(21) Appl. No.: 13/400,765

(22) Filed: Feb. 21, 2012

Related U.S. Application Data
(60) Provisional application No. 61/445,306, filed on Feb. 22, 2011.

(51) Int. Cl. E05B 73/00; B23P 17/00

(52) U.S. Cl. 70/15; 29/525.03

(57) ABSTRACT

The present invention relates to a yoke device for use in combination with a security device. The security device includes a housing and a cable having a first end and a second end, whereby the second end is secured to the housing. The yoke device includes a first leg, a second leg, and a base portion extending therebetween.

An eyelet or loop extends from each leg portion to define an opening therein. Each opening is sized to allow the first end of the cable to pass therethrough to facilitate forming a loop around an article of goods, while simultaneously securing the yoke device to the security device such that a first portion and a second portion of the article cannot be separated.

### CROSS-REFERENCE TO RELATED APPLICATION

This application claims priority from U.S. Provisional Application Ser. No. 61/445,306, filed Feb. 22, 2011, the disclosure of which is incorporated herein by reference.

### BACKGROUND OF THE INVENTION

1. Technical Field

This invention relates generally to security devices for preventing theft of an article of goods. More particularly, this invention relates to a yoke device for use in combination with a security device having a looped cable for securing said article. Specifically, this invention relates to a yoke device having a pair of openings for receiving a portion of the looped cable to prevent two removably secured portions of the article from separating, thus preventing theft of either of the portions and the article as a whole.

2. Background Information

Various retail establishments use numerous types of theft deterrent systems and devices to discourage shoplifting. Many of these devices attach to the article to be protected by cables which wrap around the device or extend through portions of the device or are secured thereto in other manners. The cable lock security device will sound an alarm if the security device itself is tampered with, such as cutting the attachment cable. Also, the security device will carry an EAS tag which will actuate an alarm of a security gate that is usually located at the exit of the retail establishment. These security devices contain an alarm system which includes an audible alarm which emits a high pitched alarm sound through a speaker, such as a piezoelectric speaker, mounted in the security device. The alarm alerts store personnel that the article being protected thereby is being tampered with, as well as possible tampering of the security device itself.

While these cable lock-style security devices are extremely useful for securing monolithic one-piece articles such as leather jackets, there exists a class of articles which are generally comprised of two main portions which are removably secured together. Each portion is separately valuable in the market, thus a shoplifter need only separate and remove one of the portions to shoplift a valuable item. For example, a cordless drill typically includes a drill portion and a battery portion removably secured thereto, wherein both portions are separately valuable. If a standard style cable lock security device is secured to the drill portion around the handle, a shoplifter could disconnect the battery portion and steal only this unsecured portion, leaving the secured drill portion behind. A retail seller of the cordless drill may attempt to protect both portions. However, this necessitates securing a cable lock security device to both portions of the article, thus requiring twice the inventory of cable lock security devices. Inasmuch as these security devices represent a non-trivial expense to a retail seller and require time during check-out to remove, most sellers do not apply more than one cable lock security device to a particular article.

Thus, the need exists for a yoke device for use in combination with a security device, whereby the yoke device facilitates securing both portions of an article together, and whereby the yoke device itself is secured to the cable lock security device. This yoke device needs to be inexpensive, such that a retail seller would incur a minimal cost to upgrade the existing cable lock style inventory to protect both portions of an article of goods.

### BRIEF SUMMARY OF THE INVENTION

The present invention relates to a yoke device for use in combination with a security device. The security device includes a housing and a cable having a first end and a second end, whereby the second end is secured to the housing. The yoke device includes a first leg, a second leg, and a base portion extending therebetween. An eyelet or loop extends from each leg portion to define an opening therein. Each opening is sized to allow the first end of the cable to pass therethrough to facilitate forming a loop around an article of goods, while simultaneously securing the yoke device to the security device such that a first portion and a second portion of the article cannot be separated.

### BRIEF DESCRIPTION OF THE SEVERAL VIEWS OF THE DRAWINGS

A preferred embodiment of the invention, illustrated of the best mode in which Applicant contemplates applying the principles, is set forth in the following description and is shown in the drawings and is particularly and distinctly pointed out and set forth in the appended claims.

FIG. 1 is a perspective view of a first embodiment of the present invention secured to a drill and drill battery;

FIG. 2 is a perspective view of a yoke device of the first embodiment of the present invention; and

FIG. 3 is a perspective view of a second embodiment of the present invention secured to a rod and a reel.

Similar numbers refer to similar parts throughout the drawings.

### DETAILED DESCRIPTION OF THE INVENTION

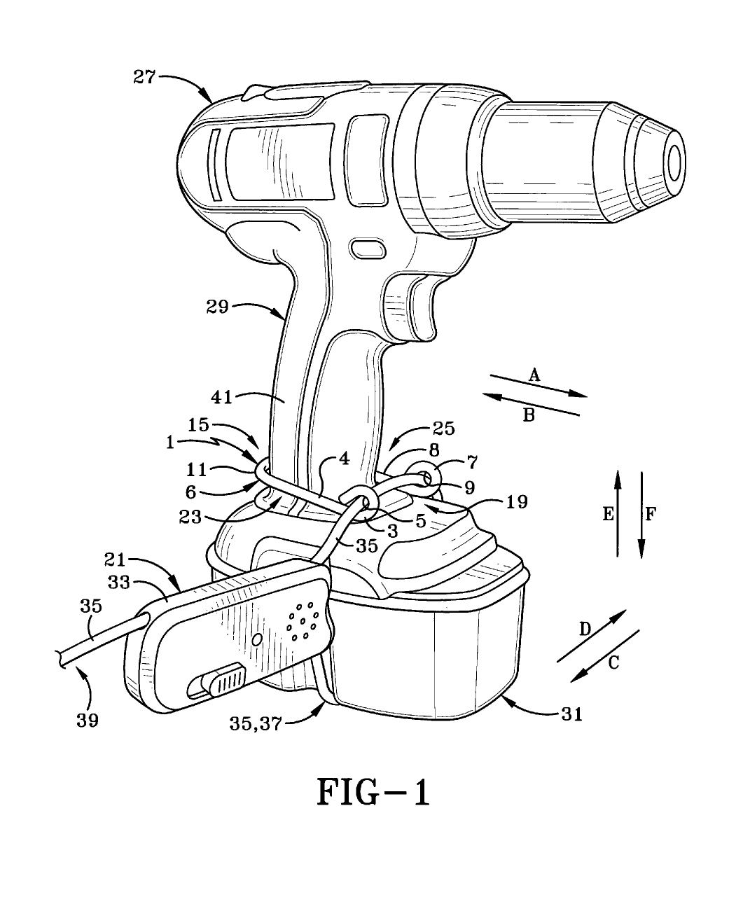

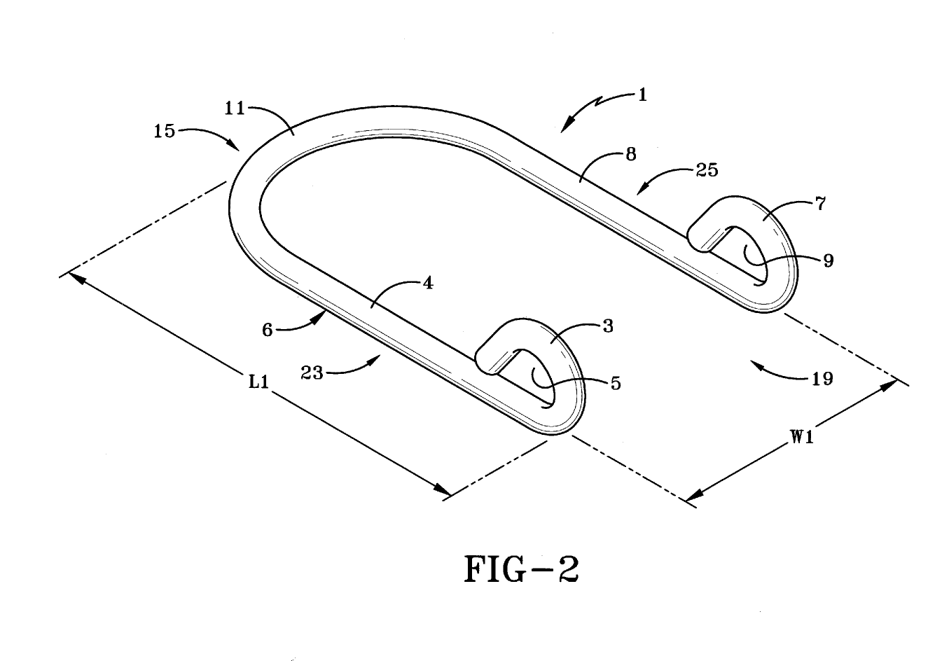

A yoke device of the present invention for use in combination with a security device is shown in FIGS. 1-3. A first embodiment of such a yoke device is shown in FIGS. 1 and 2, and is indicated generally at 1. Yoke device 1 is generally U-shaped having a first eyelet 3 extending from a first leg 4, and a second eyelet 7 extending from a second leg 8, whereby a base portion 11 extends between first leg 4 and second leg 8. First eyelet 3 defines a first opening 5 and second eyelet 7 defines a second opening 9. Yoke device 1 generally includes a first end 15 proximate base 11 and a spaced apart second end 19 proximate first eyelet 3 and second eyelet 7. Yoke device 1 further includes a first side 23 proximate first leg 4 and a second side 25 proximate second leg 8.

As shown in FIGS. 1 and 2, yoke device 1 is preferably formed from a monolithic beam 6 of material, which may be comprised of steel, reinforced plastic, or cable material. Monolithic beam 6 may be formed or composed without joints or seams. As such, first eyelet 3 and second eyelet 7 may be formed by bending beam 6 into an eyelet shape. As shown in FIG. 2, yoke device 1 includes an overall length of L1 and an overall width of W1. One will readily understand that L1 and W1 may be customized and configured to better conform to a particular size requirement of the user.

Yoke device 1 is intended to be used in combination with an existing cable lock security device 21, hereafter referred to as a cable lock 21, which includes a housing 33 and a cable 35 having a movable first end 39 and a second end fixedly secured within housing 33. As readily understood in the art, cable 35 may form a loop 37 by way of first end 39 extending outwardly away from housing 35 and back through housing 35 to form loop 37. Loop 37 is typically formed around article 27 as the means for securing cable lock 21 to article 27. Thereafter, first end 39 of cable 35 may extend outwardly away from housing 33 such that by pulling on first end 39, loop 37 is tightened around article 27. Cable 35 and loop 37 are securely held in this position until released by a key (not shown), which may be magnetic in nature, and which interacts with internal mechanisms in housing 35 to release first end 39 of cable 35 from housing 35, thereby opening loop 37 and releasing article 27.

Article 27 is comprised of a first portion 29 removably secured to a second portion 31. Shown in an exemplary embodiment in FIGS. 1 and 2, first portion 29 is comprised of a drill, hereinafter referred to as drill 29, and second portion 31 is comprised of a drill battery, hereinafter referred to as a battery 31. Yoke device 1 primarily aids in securing article 27 by preventing the removable connection between drill 29 and battery 31 from being realized. Thus, when cable lock 21 and yoke device 1 are connected by way of threading cable 35 through first eyelet 3 and second eyelet 7, and loop 37 is subsequently tightened around article 27, drill 29 and battery 31 are held securely together such that they cannot be separated.

It is a primary feature of the present invention that cable 35 is engaged with first eyelet 3 and second eyelet 7 while loop 37 is secured around article 27. Furthermore, it is another primary feature of the present invention that yoke device 1 is oriented to secure a portion of article 27 in a yoke-like configuration, preferably around a portion of article 27 which is not secured by loop 37. As shown in FIG. 1, it is another primary feature of the present invention that loop 27 exists in an imaginary first plane, and yoke device 1 extends around a portion of article 27 in a tangential intersecting second plane with respect to first plane. Thus, by connecting cable lock 21 to yoke device 1 and extending loop 37 and yoke device 1 around different portions of article 27, first portion 29 and second portion 31 are secured together to prevent separation, and article 27 is secured overall to prevent theft.

In operation, a user wishes to secure article 27 by way of cable lock 21 and yoke device 1. In the present example, drill 29 includes a handle 41 having an overall cross-sectional shape which lends itself to convenient mating with yoke device 1. The user places yoke device 1 in a yoke-like orientation around handle 41, such that handle 41 is between first end 15 and second end 19, and further between first side 23 and second side 25, essentially directly in the middle of the U-shape of yoke device 1. First end 39 of cable 35 is then extended around battery 31 and thereafter around drill 29 proximate handle 41. The user then threads first end 39 of cable 35 through each eyelet, first through second eyelet 7 by way of second opening 9, then through first eyelet 4 by way of first opening 5. First end 39 is then plunged into housing 33, such that loop 37 is formed around article 27 and through first eyelet 3 and second eyelet 5. First end 39 extends through housing 33 and outwardly away from housing 33 and article 27, such that the user can pull first end 39 to tighten loop 37 around article 27, forming a secure connection between cable lock 21 and article 27.

As shown in FIGS. 1 and 2, when cable lock 21 and yoke device 1 are secured to article 27, any effective movement of cable lock 21 and yoke device 1 is thereby prevented by the orientation of cable 35 and yoke device 1 on article 27. Movement in the direction of Arrow A is prevented by base portion 11 abutting handle 41; movement in the direction of Arrow B is prevented by cable 35 abutting handle 41; and movement in the direction of Arrows C, D, E, and F is prevented by the tight nature of loop 37 and cable 35 around drill 29 and battery 31. Furthermore, battery 31 is prevented from being removed from drill 29 by way of loop 37 and yoke device 1, such that neither drill 29 nor battery 31 can be separately removed from article 27.

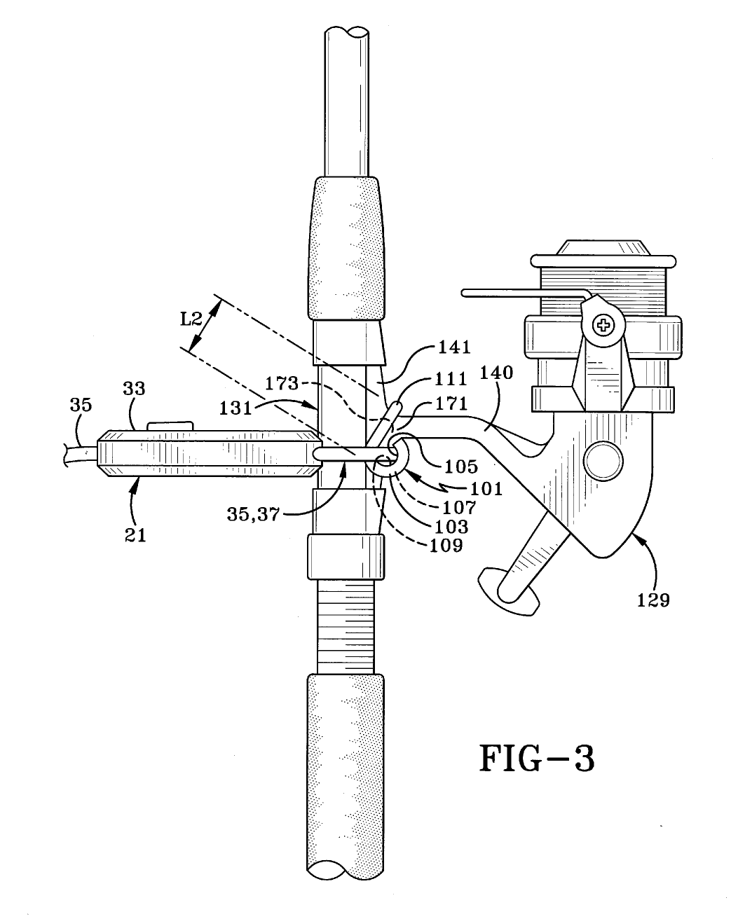

A second embodiment of the present invention is shown in FIG. 3 and is indicated generally at 101. Yoke device 101 includes a base portion 111 extending between a first loop 103 and a second loop 107. Yoke device 101 embodies the same general inventive features as yoke device 1, however, first leg 4 and second leg 8 of yoke device 1 have been eliminated in yoke device 101 to shorten the overall length of yoke device 101 to better conform the overall structure of yoke device 101 for securing an article 127. As shown in FIG. 3, yoke device 101 includes an overall length L2. As shown in FIGS. 2 and 3, L1 and L2 are configured to fittingly engage with the respective articles 27 and 127, respectively.

First loop 103 and second loop 107 of yoke device 101 are formed in place of first eyelet 3 and second eyelet 7 of yoke device 1, respectively. While first eyelet 3 and second eyelet 7 are generally closed structures, first loop 103 defines a first passage 171 and second loop 107 defines a second passage 173. First passage 171 and second passage 173 are generally defined to allow the width of cable 35 to pass therethrough, whereas first eyelet 3 and second eyelet 7 do not include such a feature. First loop 103 further defines a first opening 105 therein and second loop 107 further defines a second opening 109 therein.

Similar to article 27, article 127 is comprised of a first portion 129 removably secured to a second portion 131 to form article 127. Shown in an exemplary embodiment in FIG. 3, first portion 129 is comprised of a fishing reel, hereinafter referred to as reel 129, and second portion 131 is shown as a fishing rod, hereinafter referred to as rod 131. Yoke device 101 aids in securing article 127 by preventing the removable connection between reel 129 and rod 131 from being realized. Reel 129 includes unique features which necessitate the modifications of yoke device 101 with respect to yoke device 1. Rod 129 includes a bracket 141 extending from a neck 140. Bracket 141 abuts rod 131 to form the removable connection between rod 131 and reel 129 in article 127. It will readily be understood that neck 140 has a smaller cross-sectional shape when compared to handle 41, thus first leg 4 and second leg 8 have been eliminated in this second embodiment to form yoke device 101. This smaller overall nature of yoke device 101 facilitates a closer fit between neck 140, bracket 141, and yoke device 101. This closer fit is required to effectively secure rod 131 and reel 129 together.

The operation of the second embodiment of the present invention, shown as yoke device 101, is similar to the operation of the first embodiment, shown as yoke device 1. However, inasmuch as first eyelet 3 and second eyelet 7 of yoke device 1 have been replaced with first loop 103 and second loop 107, respectively, cable 35 is not required to be threaded through first opening 105 and second opening 109. If desired, the user can pass cable 35 through first passage 171 and second passage 173 prior to tightening loop 37 around article 127 to dispose cable 35 in first opening 105 and second opening 109, respectively. Loop 37 may be pre-formed before cable lock 21 is connected to yoke device 101 as loop 37 can pass through first passage 171 and second passage 173 without encountering an obstruction. First passage 171 and second passage 173 are oriented relative first loop 103 and second loop 105, respectively, such that when loop 37 is tightened to secure cable lock 21 onto article 127, cable 35 is disposed distally from first passage 171 and second passage 173. It will be readily understood that loop 37 may be in a generally untightened position, where slack exists in loop 37 with respect to securing article 127. Loop 37 may also be in a generally tightened position, where minimal slack exists in loop 37 with respect to securing article 127. Thus, when loop 37 is in the untightened position, loop 37 may pass through first passage 171 and second passage 173, as the slack in loop 37 allows a user to move cable 35 up and around first loop 103 and second loop 107 to pass cable 35 through first passage 171 and second passage 173 and into first opening 105 and second opening 109, respectively. However, when loop 37 is in the tightened position, first passage 171 and second passage 173 are oriented relative yoke device 101 such that cable 35 cannot pass through first passage 171 and second passage 173 without first moving loop 37 into the untightened position. Thus, it is a primary feature of yoke device 101 that loop 37 may be pre-formed before cable lock 21 is connected to yoke device 101.

After cable 35 is disposed in first opening 5 and second opening 9, cable lock 21 may be secured to article 127 in the manner described above with respect to article 27. First end 39 of cable 35 is manually tightened to close loop 37 around rod 131 and tightly secure cable lock 21 onto article 127. Once cable lock 21 and yoke device 101 are tightly secured to article 127, rod 131 and reel 129 cannot be separated. Thus, article 127 may be conveniently displayed in the store using one cable lock 21 without the threat that a prospective thief would separate rod 131 from reel 129 and thereafter steal one of the portions of article 127.

With reference to FIGS. 1 and 2, article 27 is shown as a cordless drill with first portion 29 comprising the drill, and second portion 31 comprising the drill battery. With reference to FIG. 3, article 127 is shown as a fishing pole with first portion 129 comprising the rod, and second portion 131 comprising the reel. Thus, the overall shape of yoke device 1 conforms to use specifically with goods shaped like article 27, and the overall shape of yoke device 101 conforms to use specifically with goods shaped like 127. However, any conceivable article or good which includes at least two portions which are removably secured together are within the scope of the articles or goods intended for use with the yoke device of the present invention. Furthermore, while cable lock 21 can provide a general universal fit for mating with any article by way of adjustable loop 37, the yoke device of the present invention may be customized on a per-article basis to provide a tight locking fit around a particular portion of the given article or good, shown in FIGS. 1 and 2 as handle 41, and FIG. 3 as neck 140 and bracket 141. Thus, it is envisioned that a retail seller of various goods may have on hand a plurality of cable lock security devices for use with most any goods, and additionally have on hand several different customized yoke devices of the present invention for use in combination with a cable lock on a particular good.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A security device adapted to secure an article, the security device comprising:
a yoke device having a first leg, a second leg, and a base portion extending therebetween;
a cable selectively connectable with at least one of the first leg and second leg; and
a housing selectively connectable with the cable.

2. The security device of claim 1, further comprising a first opening defined by the first leg for selectively receiving the cable therethrough.

3. The security device of claim 2, further comprising a second opening defined by the second leg for selectively receiving the cable therethrough.

4. The combination of claim 3, further comprising:
a first eyelet extending from the first leg, wherein the first eyelet defines the first opening; and
a second eyelet extending from the second leg, wherein the second eyelet defines the second opening.

5. The security device of claim 1, further comprising a first end of the cable and a second end of the cable, wherein the second end is permanently secured to the housing, and wherein the first end of the cable is selectively lockable to the housing.

6. The security device of claim 5, wherein the first end is selectively extendable through a first opening defined by the first leg of the yoke device.

7. The security device of claim 6, wherein the first end is selectively extendable through a second opening defined by the second leg of the yoke device.

8. The security device of claim 5, further comprising a loop formed by the cable and the housing, wherein the first end of the cable extends through a first opening defined by the first leg of the yoke device and into the housing to form the loop.

9. The security device of claim 8, wherein the first end of the cable extends through both the first opening and a second opening defined by the second leg of the yoke device, and thereafter into the housing to form the loop.

10. The security device of claim 1, wherein the yoke device is comprised of a monolithic beam of a material.

11. The security device of claim 1, wherein the housing includes an alarm system.

12. A yoke device adapted for use with an alarming security device having a cable, the yoke device comprising:
an integral beam of a material having a first leg, a second leg, and a base portion extending therebetween;
a first opening defined by the first leg and adapted to receive the cable therethrough; and
a second opening defined by the second leg and adapted to receive the cable therethrough.

13. The yoke device of claim 12, further comprising a first eyelet, wherein the first eyelet defines the first opening.

14. The yoke device of claim 13, further comprising a second eyelet, wherein the second eyelet defines the second opening.

15. A method of securing a first article and a second article against theft, the method comprising the steps of:
bringing a yoke device proximate the first article;
extending a cable through a first opening defined by the yoke device;
forming a loop by engaging the cable with a housing;
disposing a portion of the second article within the loop; and
tightening the loop to releasably lock the first article and second article together.

16. The method of claim 15, further comprising the step of extending the cable through a second opening defined by the yoke device.

17. The method of claim 16, further comprising the step of disposing a portion of the first article within the loop.

18. The method of claim 15, further comprising the steps of:
unforming the loop by disengaging at least an end of the cable from the housing by way of a magnetic key; and
retracting the cable from the first opening.

19. The method of claim 18, further comprising the step of disposing a security tag in the housing.

20. The method of claim 15, further comprising the steps of:
forming the yoke device from a monolithic beam of a material; and
bending a first end of the beam to form a first eyelet, wherein the first eyelet defines the first opening.
